(19) United States
(12) Patent Application Publication
(10) Pub. No.: US 2026/0194412 A1
(43) Pub. Date: Jul. 9, 2026

(54) Seal Inspection System and Seal Inspection Method for Battery Cell

(71) Applicant: SK On Co., Ltd., Seoul (KR)

(72) Inventor: Seung Hyeon CHEON, Daejeon (KR)

(21) Appl. No.: 19/433,155

(22) Filed: Dec. 26, 2025

(30) Foreign Application Priority Data
Jan. 3, 2025 (KR) 10-2025-0000868

(51) Int. Cl. G01M 3/04; H01M 10/42; H01M 50/183

(52) U.S. Cl. CPC G01M 3/04; H01M 10/4285; H01M 50/183

(57) ABSTRACT

A seal inspection method for a battery cell includes a first deformation operation of convexly deforming a battery cell, a depressurization operation of reducing internal pressure of the battery cell, a gas injection operation of injecting gas into the battery cell, and a sealing operation of installing a sealing member in an inlet of the battery cell.

### CROSS-REFERENCE TO RELATED APPLICATION(S)

This patent document claims the priority and benefits of Korean Patent Application No. 10-2025-0000868 filed on January 3, 2025, the disclosure of which is incorporated herein by reference in its entirety.

### TECHNICAL FIELD

The disclosure and implementations disclosed in this patent document generally relate to a seal inspection system and a seal inspection method for battery cells.

### BACKGROUND

Unlike primary batteries, secondary batteries may be charged with and discharged of electricity, and thus may be applied to a variety of applications, including digital cameras, mobile phones, laptops, hybrid vehicles, electric vehicles, and energy storage systems (ESS). Secondary batteries may be lithium-ion batteries, nickel-cadmium batteries, nickel-metal hydride batteries, or nickel-hydrogen batteries.

Secondary batteries are manufactured as flexible pouch-type battery cells or rigid prismatic or cylindrical can-type battery cells. A plurality of battery cells may be formed into a stacked cell assembly.

The cell assembly may be disposed within a module housing to form a battery module, and a plurality of battery modules may be disposed within a pack frame to form a battery pack.

### SUMMARY

In the related art, during a seal inspection of a battery cell, if the internal pressure of the battery cell is reduced to a certain value or lower, the electrolyte may be discharged, and if the interior is not sufficiently depressurized, the battery cell may bulge due to the weight of the electrolyte, resulting in the problem of the battery cell becoming thicker than designed.

The present disclosure may be implemented in some embodiments to secure the designed thickness of a battery cell.

The present disclosure may be implemented in some embodiments to improve the accuracy of a seal inspection for a battery cell.

A seal inspection system and a seal inspection method for a battery cell may be widely applied to devices in green technology fields, such as electric vehicles, battery charging stations, and other battery-powered solar and wind power generation. Furthermore, the seal inspection system and the seal inspection method for a battery cell may be used in eco-friendly electric vehicles, hybrid vehicles, and other vehicles for ameliorating the effects of climate change by suppressing air pollution and greenhouse gas emissions.

In some embodiments of the present disclosure, a seal inspection method for a battery cell includes: a first deformation operation of convexly deforming a battery cell; a depressurization operation of reducing internal pressure of the battery cell; a gas injection operation of injecting gas into the battery cell; and a sealing operation of installing a sealing member in an inlet of the battery cell.

The seal inspection method may further include: a second deformation operation of concavely deforming the battery cell, wherein the second deformation operation is performed after the sealing operation.

The seal inspection method may further include: a determination operation of determining gas leakage.

In the determination operation, whether sealing is sufficient may be determined based on an amount of gas leakage when vacuum is applied to the inlet in a state in which the sealing member is installed.

The depressurization operation, the injection operation, and the sealing operation may be performed in a state in which the battery cell is convexly deformed through the first deformation operation.

The gas may be an inert gas.

The inert gas may be helium.

In some embodiments of the present disclosure, a seal inspection system for a battery cell includes: a fixing unit structured to secure a battery cell; an adsorption unit structured to be attached to a side surface of the battery cell; and a sealing unit structured to communicate with an interior of the battery cell, wherein the sealing unit communicates with the battery cell in a state in which the adsorption unit convexly deforms the battery cell.

The seal inspection system may further include: a determination unit of determining whether the battery cell is sealed.

The determination unit may include a gas detection unit detecting leaked gas.

The determination unit may further include a diagnostic unit diagnosing whether sealing is sufficient through an amount of detected gas.

The sealing unit may include: a depressurization unit depressurizing the interior of the battery cell; a gas injection unit injecting gas into the interior of the battery cell; and a sealing member installation unit installing a sealing member in an inlet of the battery cell to seal the inlet.

The gas injection unit and the sealing member installation unit may be disposed inside the depressurization unit.

The adsorption unit may include: a vacuum pad structured to be attached to the side surface of the battery cell; and a vacuum pad moving unit structured to move the vacuum pad.

The gas may be an inert gas.

The inert gas may be helium.

### BRIEF DESCRIPTION OF DRAWINGS

Certain aspects, features, and advantages of the present disclosure are illustrated by the following detailed description with reference to the accompanying drawings.

FIG. 1 is a perspective view of a battery cell according to an embodiment;

FIG. 2 is a flowchart of a seal inspection method for a battery cell according to an embodiment;

FIGS. 3A to 3F are schematic diagrams sequentially illustrating the operation of a seal inspection system for a battery cell according to an embodiment;

FIGS. 4A to 4C are cross-sectional views sequentially illustrating the operation of a sealing unit of a seal inspection system for a battery cell according to an embodiment;

FIG. 5 is a schematic diagram briefly illustrating a determination unit of a seal inspection system for a battery cell according to an embodiment; and

FIG. 6 is a plan view illustrating a portion of a seal inspection system for a battery cell and an upper portion of a battery cell according to an embodiment.

### DETAILED DESCRIPTION

The same reference numerals or symbols respectively illustrated in the attached drawings denote parts or elements that perform the actually same functions. For convenience of description and understanding, the parts or elements will be described by using the same reference numerals or symbols even in different embodiments. In other words, although elements having the same reference numerals are all illustrated in a plurality of drawings, the plurality of drawings do not mean an embodiment.

As used herein, the singular forms are intended to include the plural forms as well, unless the context clearly indicates otherwise. It will be further understood that the terms “comprises,” “comprising,” etc. when used in this specification, specify the presence of stated features, integers, steps, operations, elements, and/or components, but do not preclude the presence or addition of one or more other features, integers, steps, operations, elements, components, and/or groups thereof.

In addition, in the present specification, the expressions, such as an upper side, a lower side, a side face, a rear surface, and the like, are described based on the drawings and may be expressed differently when the direction of the corresponding object is changed.

The terms including ordinal numbers, such as ‘first,’ ‘second,’ etc. may be used herein to distinguish elements from one another. These ordinal numbers are merely used to distinguish the same or similar elements from one another, and meanings of the terms are not construed as being limited by the using of the ordinal numbers. For example, use orders or arrangement orders of elements combined with these ordinal numbers are not limited by numbers thereof. The ordinal numbers may be replaced with one another.

Hereinafter, embodiments of the present disclosure will be described in detail with reference to the accompanying drawings. However, the embodiments may be modified in various manners, and the scope is not limited to the embodiments described below.

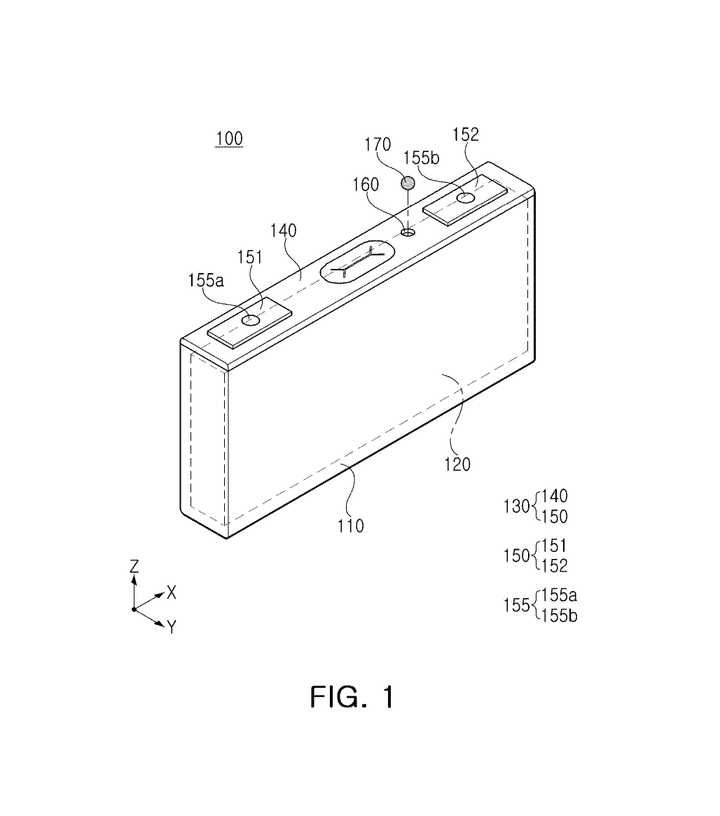

FIG. 1 is a perspective view of a battery cell 100 according to an embodiment.

Referring to FIG. 1, the battery cell 100 according to an embodiment may be a prismatic battery cell packaged in a rectangular parallelepiped shape.

According to an embodiment, the battery cell 100 may include an electrode assembly 120, a cell case 110 including an accommodation space accommodating the electrode assembly 120, and a cap assembly 130 sealing the accommodation space.

The cell case 110 may have a rectangular parallelepiped shape. The cell case 110 may be formed of aluminum. The cell case 110 may have the accommodation space therein, and the accommodation space may accommodate the electrode assembly 120 and an electrolyte.

The electrode assembly 120 may be formed by stacking a plurality of electrode plates and a separator interposed therebetween. Specifically, the electrode plates may include a positive electrode plate in which a positive active material is applied to at least one surface of a current collector and a negative electrode plate in which a negative active material is applied to at least one surface of the current collector. That is, each of the plurality of electrode plates of the electrode assembly 120 may include a coated portion coated with a positive or negative active material and an uncoated portion not coated with the active material.

Meanwhile, each of the plurality of electrode plates may include an uncoated portion. For convenience of understanding, the term ‘uncoated portion’ in the present disclosure should be understood to include a plurality of uncoated portions, although expressed in the singular form.

The separator may be configured to prevent an electrical short-circuit between the positive and negative electrode plates and to facilitate ion flow. For example, the separator may include a porous polymer film or porous non-woven fabric.

According to an embodiment, the electrode assembly 120 may be formed by sequentially stacking the positive and negative electrode plates, with a separator interposed therebetween. In some embodiments, the electrode assembly 120 may be a winding type, a stacking type, a zigzag folding type, or a stack-folding type. However, the electrode assembly 120 of the present disclosure is not particularly limited as long as it has a structure formed by repeatedly arranging a positive electrode, a separator, and a negative electrode.

The electrolyte may include a lithium salt, such as LiPF6 or LiBF4, in an organic solvent, such as ethylene carbonate (EC), propylene carbonate (PC), diethyl carbonate (DEC), ethyl methyl carbonate (EMC), or dimethyl carbonate (DMC). Also, the electrolyte may be in a liquid, solid, or gel state.

The cell case 110 may include an opening on at least one side. The cap assembly 130 may be disposed in the opening and may include a cap plate 140 covering the opening and sealing the internal space.

For example, the cell case 110 may include the opening on one side in the Z-axis direction based on the drawing. The opening may have a length in the longer side direction (the X-axis direction) of the cell case 110, and the cap plate 140 may be disposed to cover the opening.

The cap plate 140 may be coupled to the cell case 110, while disposed to cover the opening. The cap plate 140 may be formed of aluminum and may be welded to the cell case 110 along the perimeter of the opening.

The cap plate 140 may include an inlet 160 serving as a passage through which electrolyte may be injected into the cell case. The inlet 160 may be sealed with a sealing member 170 after the electrolyte is injected.

The cap assembly 130 may include electrode terminals (150: 151, 152). For example, the cap assembly 130 may include a negative terminal 151 and a positive terminal 152. The negative terminal 151 may be electrically connected to the negative electrode plate of the electrode assembly 120 and have a negative polarity, while the positive terminal 152 may be electrically connected to the positive electrode plate of the electrode assembly 120 and have a positive polarity.

According to an embodiment, the negative terminal 151 and the positive terminal 152 may be provided in the form of plates and may be spaced apart from each other in the length direction on one surface of the cap plate 140. The one surface of the cap plate 140 may refer to the surface opposite the surface facing the internal space. However, the negative terminal 151 and the positive terminal 152 are not limited to the aforementioned embodiment, as long as they are electrically connected to the outside.

According to an embodiment, the negative terminal 151 and the positive terminal 152 may be electrically connected to a current collector plate. The current collector plate may be connected to the uncoated portion of the electrode assembly 120 and have a negative or positive polarity. The negative terminal 151 may be electrically connected to a negative current collector plate, to which the uncoated portion of the negative electrode plate is welded, and the positive terminal 152 may be electrically connected to a positive current collector plate, to which the uncoated portion of the positive electrode plate is welded.

According to an embodiment, the negative terminal 151 and the positive terminal 152 may each be electrically connected to the current collector plate via a connection pin (155: 155a, 155b). For example, a through-hole may be formed in the electrode terminal 150, and the connection pin 155 may be disposed to pass through the through-hole. One side of the connection pin 155 may be welded to the current collector plate, and the other side thereof may be welded to the electrode terminal 150. However, the method of electrically connecting the electrode terminal 150 to the electrode plate is not limited to the aforementioned embodiment.

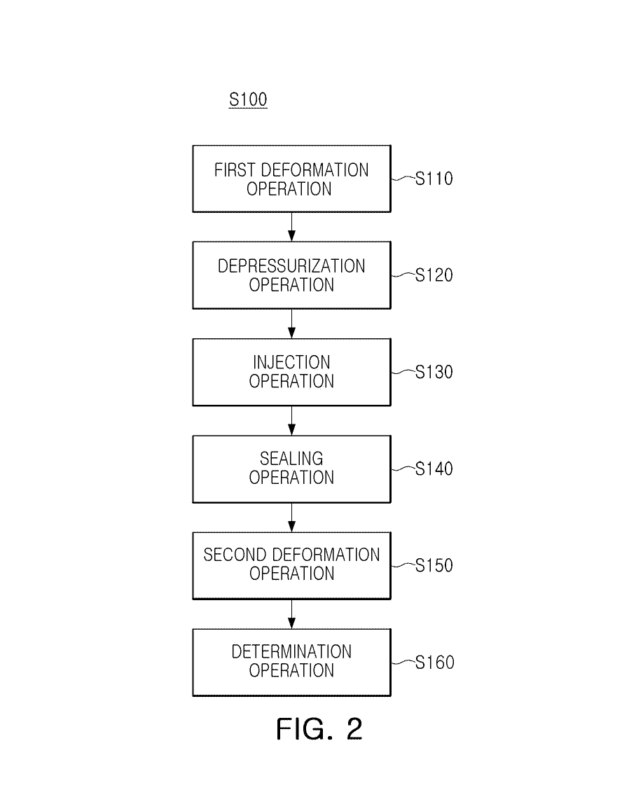

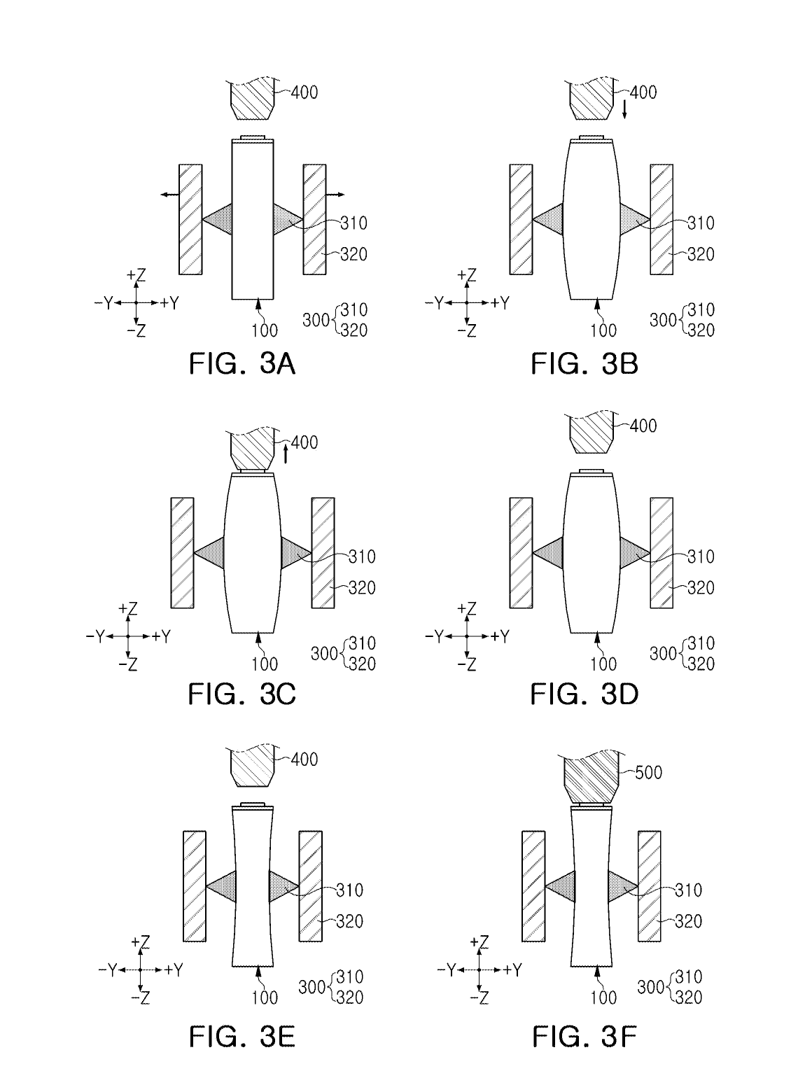

FIG. 2 is a flowchart of a seal inspection method (S100) for a battery cell according to an embodiment. FIGS. 3A through 3F are schematic diagrams sequentially illustrating the operation of a seal inspection system for the battery cell 100 according to an embodiment.

The description of the battery cell 100 of FIG. 1 may be equally applied to the battery cell 100 of FIGS. 2 and 3.

Referring to FIG. 2 along with FIGS. 3A and 3B, the seal inspection method (S100) for a battery cell according to an embodiment of the present disclosure may include a first deformation operation (S110) of convexly deforming the battery cell 100.

The first deformation operation (S110) may refer to an operation in which an adsorption unit 300, structured to be adsorbed to the side surface of the battery cell 100, is attached to the side surface of the battery cell 100 and then moves in an outward direction of the side surface of the battery cell 100, thereby deforming the battery cell 100 convexly.

Here, the side surface of the battery cell 100 may refer to a relatively wide surface among the surfaces of the cell case (110 in FIG. 1). Therefore, the side surface of the battery cell 100 may include a pair of facing surfaces.

Since the side surface of the battery cell 100 includes a pair of facing surfaces, the adsorption unit 300 may include a pair of adsorption units 300 facing each other with the battery cell 100 interposed therebetween to correspond thereto.

According to an embodiment, the adsorption unit 300 may include a vacuum pad 310 structured to be attached to the side surface of the battery cell 100 and a vacuum pad moving unit 320 structured to move the vacuum pad 310.

The vacuum pad 310 may adhere to the side surface of the battery cell 100 to block air inside and outside the vacuum pad 310. The vacuum pad 310 may be connected to a depressurizing member. The pressure within the vacuum pad 310 may be reduced by the depressurizing member.

The internal pressure of the vacuum pad 310 may be reduced by the depressurizing member, while the vacuum pad 310 is in close contact with the side surface of the battery cell 100, thereby improving the coupling force with the side surface of the battery cell 100. That is, the vacuum pad 310 may have two states: a “close contact state,” in which the vacuum pad 310 simply contacts the side surface of the battery cell 100, and a “coupled state,” in which the internal pressure of the vacuum pad 310 is reduced and the coupling force with the side surface of the battery cell 100 is improved. In this disclosure, “attachment” refers to the coupled state.

The vacuum pad moving unit 320 may move the vacuum pad 310 in the coupled state in the outward direction of the side surface of the battery cell 100, thereby deforming the battery cell 100 convexly. For example, the +Y-directional vacuum pad moving unit 320 may move the +Y-directional vacuum pad 310 in the +Y direction, and the -Y-directional vacuum pad moving unit 320 may move the -Y-directional vacuum pad 310 in the -Y direction, thereby deforming the battery cell 100 convexly.

The vacuum pad moving unit 320 may include a robot arm, a cylinder using hydraulic or pneumatic pressure, a ball screw connected to a rotating shaft of a motor, and a transfer nut converting a rotational motion of the ball screw into linear motion. However, the vacuum pad moving unit 320 is not limited thereto and may be appropriately selected and applied by considering the manufacturing environment.

When the battery cell 100 is convexly deformed, the volume of the battery cell 100 may increase. Therefore, even if the pressure in the interior of the battery cell 100 is lower than that of the related art during a depressurization operation (S120), to be described below, the electrolyte in the interior of the battery cell 100 may not be discharged.

For example, when the battery cell 100 is not convexly deformed, the electrolyte in the interior of the battery cell 100 may be discharged if the internal pressure of the battery cell 100 falls below approximately -50 kPa. However, when the battery cell 100 is convexly deformed, the electrolyte in the interior may not be discharged even if the internal pressure of the battery cell 100 is reduced to approximately -90 kPa.

In other words, the seal inspection method (S100) for a battery cell and the seal inspection system for a battery cell of the present disclosure may further reduce the internal pressure of the battery cell 100, compared to related art methods, and accordingly, the battery cell 100 may more easily be concavely deformed and may be maintained in the concavely deformed state. Furthermore, the battery cell 100 may be prevented from being convexly deformed due to gas generated within the battery cell 100 or the amount of deformation may be reduced.

Referring to FIG. 2 together with FIG. 3C, according to an embodiment of the present disclosure, the seal inspection method (S100) for a battery cell may include the depressurization operation (S120) of reducing the internal pressure of the battery cell 100, an injection operation (S130) of injecting gas into the battery cell 100, and a sealing operation (S140) of installing a sealing member into the inlet 160 of the battery cell 100.

The depressurization operation (S120) may refer to an operation in which a sealing unit 400 moves in the -Z-direction to communicate with the interior of the battery cell 100 and then depressurizes the interior of the battery cell 100 through the inlet (160 of FIG. 1). “Depressurizing the interior of the battery cell 100” may be expressed as “applying vacuum to the interior of the battery cell 100”. Applying vacuum to the battery cell 100 refers to reducing the pressure within the battery cell 100 to a level lower than that of atmospheric pressure.

The injection operation (S130) may be performed after the depressurization operation (S120) and may refer to an operation of injecting gas into the depressurized battery cell 100. The gas may be injected while monitoring the pressure within the battery cell 100. When the pressure within the battery cell 100 reaches a preset value, the gas injection may be stopped.

The sealing operation (S140) may be performed after the injection operation (S130) and may refer to an operation of installing the sealing member (170 in FIG. 1) into the inlet (160 in FIG. 1) to seal the battery cell 100 into which gas has been injected.

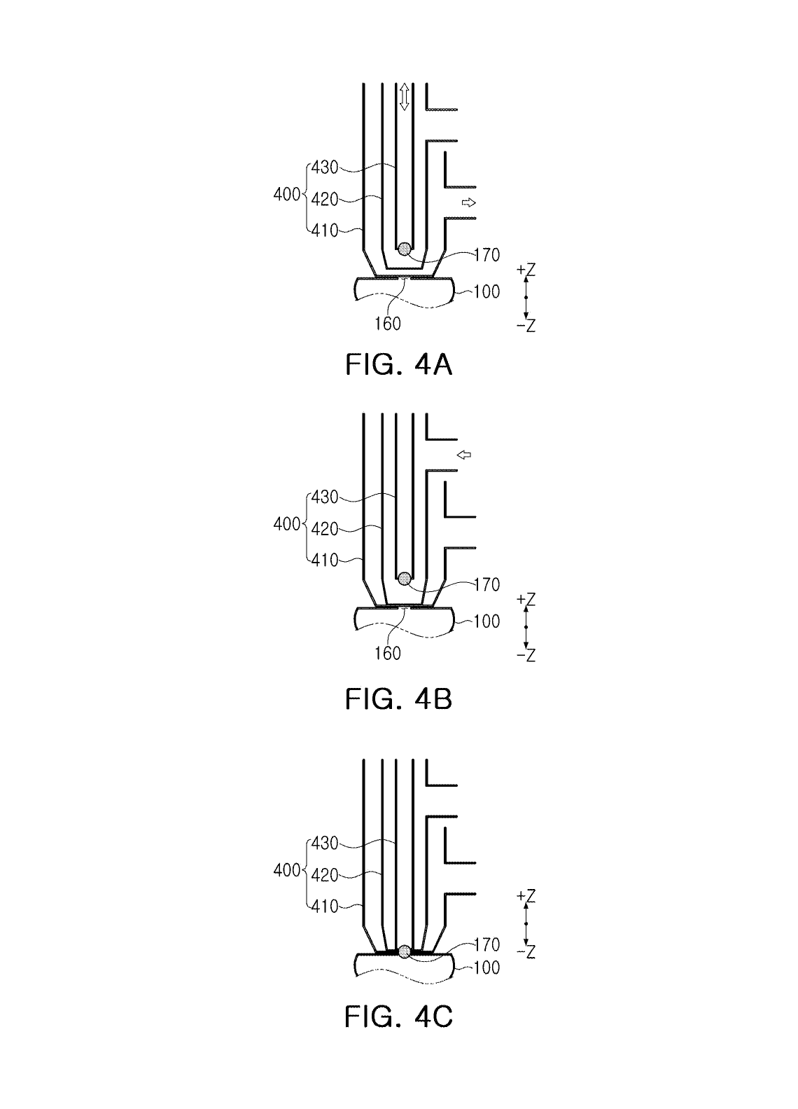

Detailed descriptions of the depressurization operation (S120), the injection operation (S130), and the sealing operation (S140) will be described below with reference to FIG. 4.

Referring to FIG. 2 along with FIG. 3D and 3E, according to an embodiment, the seal inspection method (S100) for a battery cell may further include a second deformation operation (S150) of concavely deforming the battery cell 100, and the second deformation operation (S150) may be performed after the sealing operation (S140).

After the sealing operation (S140), the sealing unit 400 may move in the +Z-direction to be separated from the battery cell 100. The second deformation operation (S150) may be performed after the sealing unit 400 is separated from the battery cell 100. The second deformation operation (S150) may refer to an operation of concavely deforming the battery cell 100, which was convexly deformed in the first deformation operation (S110). As the battery cell 100 is deformed to be concave, the designed thickness of the battery cell 100 may be secured.

The second deformation operation (S150) may be performed by the adsorption unit 300 operating in reverse to the first deformation operation (S110). Specifically, the vacuum pad moving unit 320 may move the vacuum pad 310 in a coupled state in the inward direction of the side surface of the battery cell 100 to concavely deform the battery cell 100. For example, the +Y-directional vacuum pad moving unit 320 may move the +Y-directional vacuum pad 310 in the -Y direction, and the -Y-directional vacuum pad moving unit 320 may move the -Y-directional vacuum pad 310 in the +Y direction to concavely deform the battery cell 100. As the battery cell 100 is deformed to be concave, the designed thickness of the battery cell 100 may be secured.

Referring to FIG. 2 together with FIG. 3F, according to an embodiment, the seal inspection method (S100) for a battery cell may further include a determination operation (S160) of determining gas leakage.

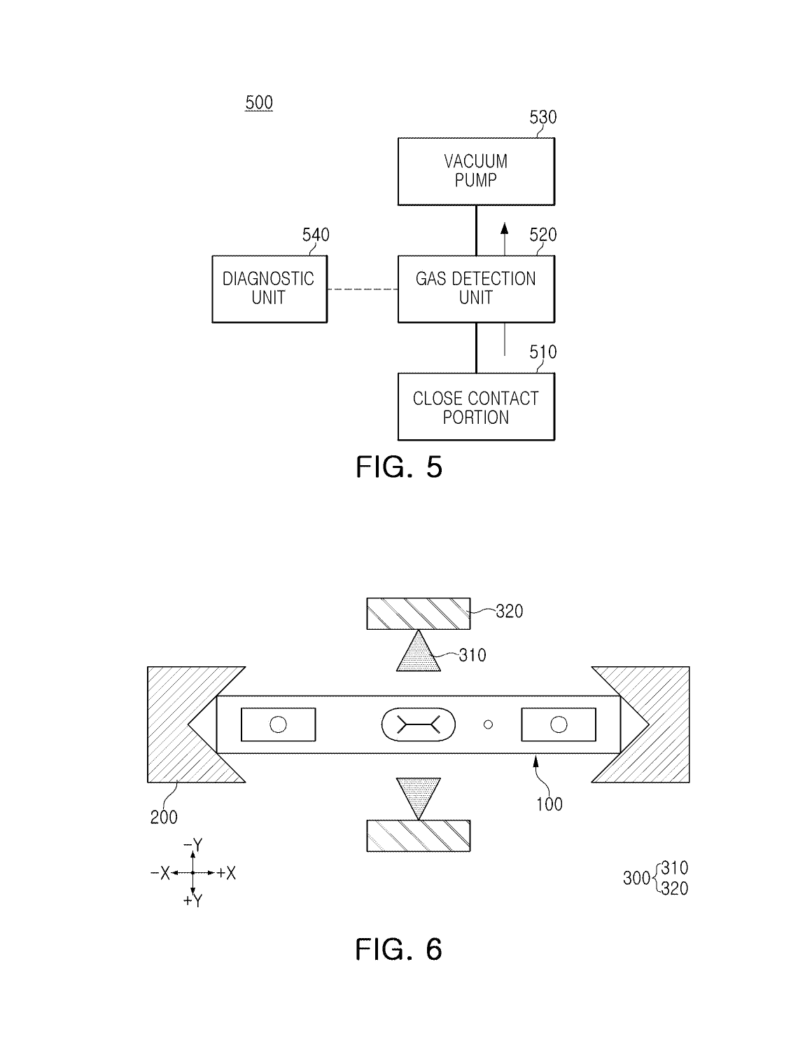

The determination operation (S160) may be performed by a determination unit 500. In the determination operation (S160), whether sealing is sufficient may be determined based on the amount of gas leakage when vacuum is applied to the inlet (160 of FIG. 1) in which the sealing member (170 of FIG. 1) is installed. Details of the determination operation will be described below with reference to FIG. 5.

FIGS. 4A to 4C are cross-sectional views sequentially illustrating the operation of the sealing unit of the seal inspection system for the battery cell 100 according to an embodiment.

The description of the battery cell 100 of FIG. 1 may also be applied to the battery cell 100 of FIG. 4.

Referring to FIG. 4 together with FIG. 2, according to an embodiment of the present disclosure, the seal inspection system for the battery cell 100 may include the sealing unit 400 structured to communicate with the interior of the battery cell 100.

According to an embodiment, the sealing unit 400 may include a depressurization unit 410 depressurizing the interior of the battery cell 100, a gas injection unit 420 injecting gas into the interior of the battery cell 100, and a sealing member installation unit installing the sealing member 170 in the inlet 160 of the battery cell 100 to seal the inlet 160.

The depressurizing operation (S120) of depressurizing the interior of the battery cell 100 may be performed by the depressurization unit 410. The depressurization unit 410 may be structured to communicate with the interior of the battery cell 100 through the inlet 160. The depressurization unit 410 may be connected to the depressurizing member to depressurize the interior of the battery cell 100.

The depressurization unit 410 may be structured to move in the Z-axis direction. Therefore, during depressurization, the depressurization unit 410 may move in the -Z-direction and be in contact with the cap plate 140, while covering the inlet 160. Subsequently, the interior of the battery cell 100 may be depressurized through the inlet 160. Alternatively, the depressurization unit 410 may apply vacuum to the interior of the battery cell through the inlet 160. Applying vacuum to the interior of the battery cell 100 refers to reducing the pressure within the battery cell 100 to a level lower than that of atmospheric pressure.

The injection operation (S130) of injecting gas into the battery cell 100 may be performed by the gas injection unit 420. The gas injection unit 420 may be disposed within the depressurization unit 410. The gas injection unit 420 may be structured to move in the Z-axis direction. Therefore, when the interior of the battery cell 100 is depressurized, the gas injection unit 420 may move in the -Z-direction, be connected to the inlet 160, and then inject gas into the battery cell 100 through the inlet 160.

The gas may be an inert gas. Inert gas may have low reactivity, which may improve the stability of the battery cell 100.

The inert gas may be helium. Helium may have a low molecular weight and may pass through even microcracks, thereby improving the accuracy of the sealing inspection.

The sealing operation (S140) of installing the sealing member 170 in the inlet 160 of the battery cell 100 may be performed by the sealing member installation unit 430. The sealing member installation unit 430 may be disposed within the depressurization unit 410. In addition, the sealing member installation unit 430 may be disposed within the gas injection unit 420. That is, the sealing member installation unit 430 may be disposed within the gas injection unit 420 located within the depressurization unit 410. The sealing member installation unit 430 may be structured to move in the Z-axis direction. Therefore, after gas is injected into the battery cell 100, the sealing member installation unit 430 may move in the -Z-direction to install the sealing member 170 in the inlet 160.

The sealing member 170 may include a ball. However, the sealing member 170 may be any shape that may seal the inlet 160, and the shape is not limited. For convenience of description, the sealing member 170 is described as a spherical ball in the present disclosure.

The diameter of the sealing member 170 may be equal to or greater than the diameter of the inlet 160. Therefore, the sealing member 170 may be installed in the inlet 160 by an interference fit to seal the inlet 160.

The sealing unit 400 may communicate with the battery cell 100 in a state in which the adsorption unit (300 in FIG. 3) deforms the battery cell 100 to be convex. In other words, the sealing unit 400 may perform the depressurization operation (S120), the injection operation (S130), and the sealing operation (S140), while the battery cell 100 is convexly deformed through the first deformation operation (S110). Since the interior of the battery cell 100 is depressurized while in the convexly deformed state, even if the interior of the battery cell 100 is further depressurized than in the related art, the electrolyte in the interior of the battery cell 100 may not be discharged. As the internal pressure of the battery cell 100 is lower than that of the related art, the battery cell 100 may be more easily deformed to be concave during the second deformation operation (S150). As the battery cell 100 is deformed to be concave, the designed thickness of the battery cell 100 may be secured.

FIG. 5 is a schematic diagram briefly illustrating the determination unit 500 of the seal inspection system for the battery cell 100 according to an embodiment.

Referring to FIG. 5 together with FIG. 1, according to an embodiment of the present disclosure, the seal inspection system for the battery cell 100 may further include the determination unit 500 of determining whether the battery cell 100 is sealed.

The determination unit 500 may include a close contact portion 510 structured to cover the inlet 160. The close contact portion 510 may contact the cap plate 140, while covering the inlet 160.

The determination unit 500 may include a vacuum pump 530 capable of depressurizing the interior of the close contact portion 510. However, any device capable of depressurizing the interior of the close contact portion 510 may be used, and is not necessarily limited to the vacuum pump 530. For convenience of description, the vacuum pump 530 is described in the present disclosure. The close contact portion 510 may be connected to the vacuum pump 530. Therefore, when the vacuum pump 530 operates, the interior of the close contact portion 510 may be depressurized. The close contact portion 510 covers the inlet 160, and thus, if the inlet 160 is not properly sealed, gas within the battery cell 100 may leak. The leaked gas may reach a gas detection unit 520 through the close contact portion 510 due to the pressure difference.

The determination unit 500 may include the gas detection unit 520 detecting gas. The gas detection unit 520 may detect gas leakage within the battery cell 100. An operator may directly determine whether the battery is sealed using the gas detection unit 520.

According to an embodiment, the determination unit 500 may further include a diagnostic unit 540 diagnosing whether the battery is sealed based on the amount of detected gas. Therefore, the determination of whether the battery is sealed may be automatically performed by the diagnostic unit 540, which diagnoses a sealing condition as defective if the amount of detected gas is equal to or greater than a preset value.

The determination unit 500 may perform a determination operation (S160 of FIG. 2). In the determination operation (S160 of FIG. 2), whether the battery is sealed may be determined based on the amount of gas leakage when vacuum is applied to the inlet 160 with the sealing member 170 installed.

The close contact portion 510 may cover the inlet 160 in which the sealing member 170 is installed and may be in contact with the cap plate 140. Applying vacuum to the inlet 160 may refer to depressurizing the interior of the close contact portion 510 covering the inlet 160, thereby reducing the pressure within the close contact portion 510 below atmospheric pressure. If the inlet 160 is not properly sealed, gas within the battery cell 100 may leak externally. Therefore, the sealing may be determined based on the amount of gas leakage.

FIG. 6 is a plan view illustrating a portion of a seal inspection system for the battery cell 100 and an upper portion of the battery cell 100 according to an embodiment.

The description of the battery cell 100 in FIG. 1 may also be applied to the battery cell 100 in FIG. 6.

Referring to FIG. 6, according to an embodiment of the present disclosure, the seal inspection system for the battery cell 100 may include a fixing unit 200 structured to secure the battery cell 100 and the adsorption unit 300 structured to be attached to the side surface of the battery cell 100.

The fixing unit 200 may secure the battery cell 100 on both sides of the battery cell 100. The fixing unit 200 may secure the battery cell 100 on both sides except for both side surfaces in which the adsorption units 300 are disposed. Therefore, the fixing unit 200 may maintain the alignment of the battery cell 100, while the adsorption unit 300 convexly deforms the battery cell 100.

The fixing unit 200 may include a pair of fixing units 200 moving in the X-axis direction on both sides and securing the battery cell 100. Specifically, the +X-directional fixing unit 200 may move in the -X direction to fix the battery cell 100, and the -X-directional fixing unit 200 may move in the +X direction to fix the battery cell 100.

The adsorption unit 300 may be attached to the side surface of the battery cell 100 fixed by the fixing unit 200, thereby convexly deforming the battery cell 100. Details of the operation of the adsorption unit 300 have been described above and are therefore omitted.

According to an embodiment, the designed thickness of the battery cell may be secured.

According to an embodiment, the accuracy of the seal inspection of the battery cell may be improved.

Only specific examples of implementations of certain embodiments are described. Variations, improvements and enhancements of the disclosed embodiments and other embodiments may be made based on the disclosure of this patent document.

What is claimed is:

1. A seal inspection method for a battery cell, the seal inspection method comprising:
a first deformation operation of convexly deforming a battery cell;
a depressurization operation of reducing internal pressure of the battery cell;
a gas injection operation of injecting gas into the battery cell; and
a sealing operation of installing a sealing member in an inlet of the battery cell.

2. The seal inspection method of claim 1, further comprising:
a second deformation operation of concavely deforming the battery cell,
wherein the second deformation operation is performed after the sealing operation.

3. The seal inspection method of claim 1, further comprising a determination operation of determining gas leakage.

4. The seal inspection method of claim 3, wherein, in the determination operation, whether sealing is sufficient is determined based on an amount of gas leakage when vacuum is applied to the inlet in a state in which the sealing member is installed.

5. The seal inspection method of claim 1, wherein the depressurization operation, the injection operation, and the sealing operation are performed in a state in which the battery cell is convexly deformed through the first deformation operation.

6. The seal inspection method of claim 1, wherein the gas is an inert gas.

7. The seal inspection method of claim 6, wherein the inert gas is helium.

8. A seal inspection system for a battery cell, the seal inspection system comprising:
a fixing unit structured to secure a battery cell;
an adsorption unit structured to be attached to a side surface of the battery cell; and
a sealing unit structured to communicate with an interior of the battery cell,
wherein the sealing unit communicates with the battery cell in a state in which the adsorption unit convexly deforms the battery cell.

9. The seal inspection system of claim 8, further comprising a determination unit of determining whether the battery cell is sealed.

10. The seal inspection system of claim 9, wherein the determination unit includes a gas detection unit detecting leaked gas.

11. The seal inspection system of claim 10, wherein the determination unit further includes a diagnostic unit diagnosing whether sealing is sufficient through an amount of detected gas.

12. The seal inspection system of claim 8, wherein
the sealing unit includes:
a depressurization unit depressurizing the interior of the battery cell;
a gas injection unit injecting gas into the interior of the battery cell; and
a sealing member installation unit installing a sealing member in an inlet of the battery cell to seal the inlet.

13. The seal inspection system of claim 12, wherein the gas injection unit and the sealing member installation unit are disposed inside the depressurization unit.

14. The seal inspection system of claim 8, wherein
the adsorption unit includes:
a vacuum pad structured to be attached to the side surface of the battery cell; and
a vacuum pad moving unit structured to move the vacuum pad.

15. The seal inspection system of claim 12, wherein the gas is an inert gas.

16. The seal inspection system of claim 15, wherein the inert gas is helium.
